(19) United States
(12) Patent Application Publication
(10) Pub. No.: US 2024/0210884 A1
(43) Pub. Date: Jun. 27, 2024

(54) MOLDED PART AND WATCH

(71) Applicant: CASIO COMPUTER CO., LTD., Tokyo (JP)

(72) Inventors: Keishiro YAMAMOTO, Tokyo (JP); Yumena KAGA, Tokyo (JP)

(21) Appl. No.: 18/390,470

(22) Filed: Dec. 20, 2023

(30) Foreign Application Priority Data
Dec. 21, 2022 (JP) 2022-204269

(51) Int. Cl. G04B 37/00; G04B 37/22

(52) U.S. Cl. CPC G04B 37/005; G04B 37/225

(57) ABSTRACT

A molded part includes a resin plate molded from resin material, and the resin plate has a sheet area of sheet-like shape and multiple assembly component parts for assemblage to a module component part, the sheet area and the multiple assembly component parts being integrated into a single unit, and the multiple assembly component parts are configured to be individually separable from the sheet area.

### CROSS-REFERENCE TO RELATED APPLICATION

This application is based upon and claims the benefit of priority under 35 USC 119 of Japanese Patent Application No. 2022-204269 filed on Dec. 21, 2022, the entire disclosure of which, including the specification, claims, drawings, and abstract, is incorporated herein by reference in its entirety.

### BACKGROUND

### Technical Field

The present disclosure relates to a molded part and a watch.

### Description of the Related Art

There has conventionally been known a molded part of a resin which includes multiple component parts for building up a model or the like. In a molded part of this type, in general, component parts are provided inside a runner which constitutes an external frame, so that the component parts are removed from the runner to build up a model. For example, Japanese Unexamined Patent Application Publication No. 2009-298085 discloses a resin molded part which is formed by molding a runner and multiple model component parts into a single molded unit through injection molding.

### SUMMARY

According to an aspect of the present disclosure, there is provided a molded part including a resin plate molded from resin material, wherein the resin plate has a sheet area of a sheet-like shape and multiple assembly component parts for assemblage to a module component part, the sheet area and the multiple assembly component parts being integrated into a single unit, and wherein the multiple assembly component parts are configured to be individually separable from the sheet area.

According to another aspect of the present disclosure, there is provided a molded part including a resin frame, molded from resin material and having a runner component part, multiple assembly component parts for assemblage to a module component part, and an edge portion having a hole formed therein, wherein the resin frame is molded from resin material and is configured to integrate the runner component part, the multiple assembly component parts, and the edge portion into a single unit; and a module component part fitted in the hole in the edge portion, wherein the multiple assembly component parts are configured to be individually separable from the runner component part.

According to a further aspect of the present disclosure, there is provided a watch including in combination a watch main body and multiple assembly component parts integrated into a single unit from resin material and configured to be assembled to the watch main body.

### BRIEF DESCRIPTION OF THE DRAWINGS

FIG. 1 is an overall perspective view of a wristwatch according to a first embodiment of the present disclosure as viewed from a front right side;

FIG. 2 is an exploded perspective view of the wristwatch according to the first embodiment;

FIG. 3 is a front view of a molded part according to the first embodiment;

FIG. 4 is a front perspective view of the molded part according to the first embodiment with a watch main body removed from the molded part; and

FIG. 5 is a front view of a molded part according to a second embodiment of the present disclosure.

### DESCRIPTION OF THE EMBODIMENT

### First Embodiment

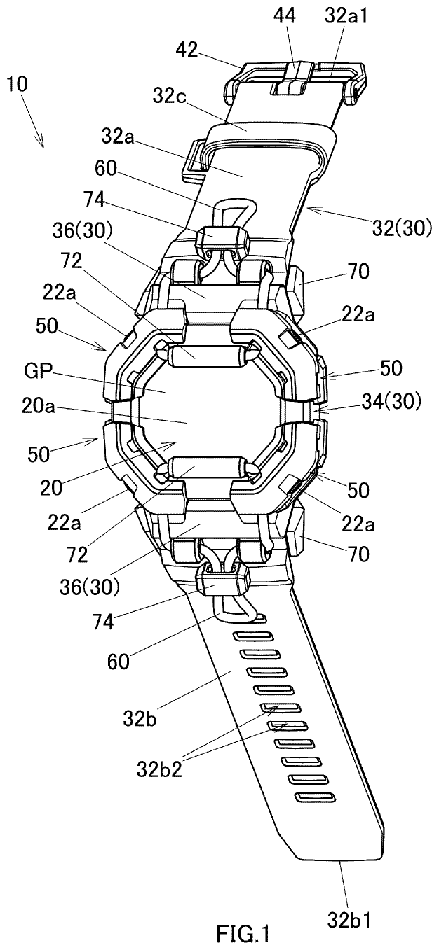

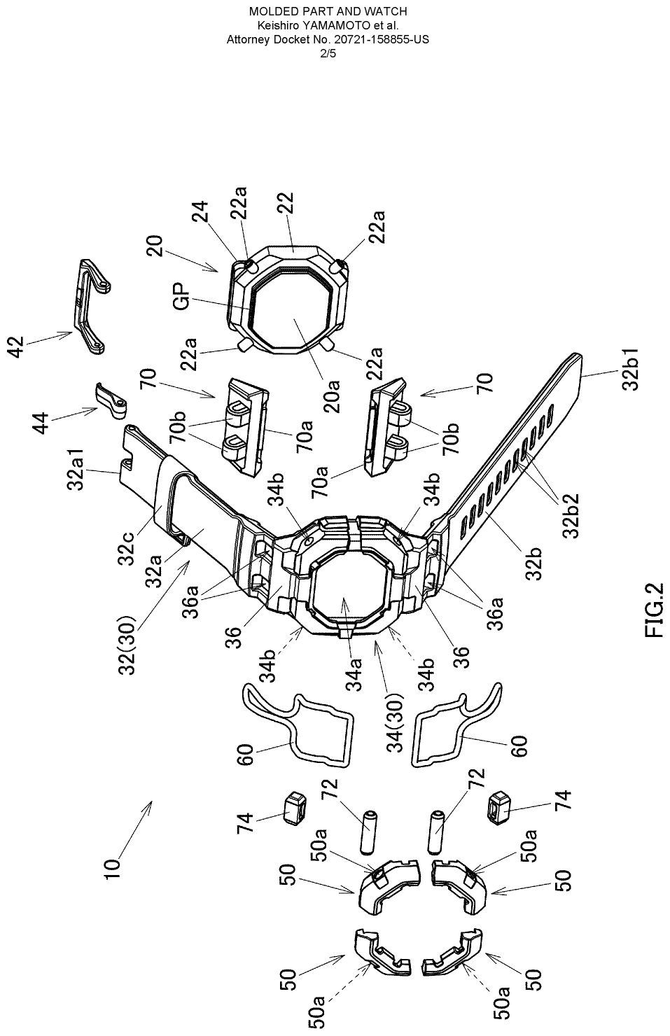

Referring to FIGS. 1 to 4, a first embodiment of the present disclosure will be described. A wristwatch (a watch) 10 shown in FIGS. 1 and 2 is made up by assembling multiple assembly component parts (hereinafter, referred to simply as “component parts”) together and screw fastening the component parts so assembled with metallic screws (not shown). Then, the wristwatch 10 has a watch main body (a module component part) 20 including a glass plate GP, a wearing component part 30 for enabling the watch main body 20 to be worn on a wrist of a user, a buckle frame component part 42 making up a buckle of the wristwatch 10, a prong component part 44 making up a prong of the wristwatch 10, four external corner component parts (external component parts) 50 configured to be assembled to the wearing component part 30, a pair of string component parts 60, a pair of string attachment component parts 70, a pair of upper and lower external component parts 72, and a pair of string fastening component parts 74. In the wristwatch 10, the component parts excluding the watch main body 20, the pair of string component parts 60, the pair of string fastening component parts 74, and the screws are formed from resin material, specifically, a urethane resin.

A dial or a display 20a is provided on a front side of the watch main body 20. The display 20a can display information such as times, dates, days of the week, and the like, which can be visualized through the glass plate GP. In the following description, with the wristwatch 10 worn on the wrist of the user and seen from the side where the information is visualized or the visualizing side, an upper side (an upper side in FIG. 1) of the wristwatch 10 is referred to as up, while a lower side of the wristwatch 10 is referred to as down. Then, a left side of the wristwatch 10 is referred to as left, while a right side of the wristwatch 10 is referred to as right. In addition, the visualizing side is referred to as a front side (a front side), while an opposite side to the visualizing side (a wrist side) is referred to as a rear side (a rear side) or a back side. In addition, with the wristwatch 10 worn on the wrist of the user, the wrist side of the wristwatch 10 is referred to as an internal side, while an opposite side to the internal side is referred to as a surface side.

As shown in FIG. 2, the watch main body 20 has a substantially regular octagonal cylindrical case 22, four crowns 22a provided in four corner portions of the case 22, and a rear lid 24 provided on a back side of the case 22. A watch module, not shown, is provided in an interior of the case 22. The watch module includes various types of precision component parts necessary for watch functions including a circuitry electrically driven to cause the display 20a to display the information such as times and the like. The glass plate GP is provided inside the case 22.

The wearing component part 30 has a band (a band component part) 32 configured to be worn on the wrist of the user, a bezel (a bezel component part) 34 in which the watch main body 20 is fitted, and a pair of connectors 36. The band 32 includes a first band 32a which is provided on an upper side of the watch main body 20, and a second band 32b which is provided on a lower side of the watch main body 20. A band loop 32c for passage of a distal end portion 32b1 of the second band 32b is provided in a position closer to a distal end portion 32al of the first band 32a. The buckle component part 42 is provided at the distal end portion 32a1 of the first band 32a. The prong component part 44 is provided inside the buckle component part 42 in such a manner as to be passed through any one of small holes 32b2 provided in the second band 32b to thereby adjust the length of the band 32.

As shown in FIG. 2, the bezel 34 has a substantially regular octagonal cylindrical shape which follows an external circumference of the watch main body 20 and is sized one size larger than the watch main body 20. The bezel 34 has an opening 34a which is opened in a front-rear direction, and the watch main body 20 is fitted in an inside of the opening 34a from a rear side of the bezel 34, whereby the watch main body 20 is assembled in such a manner as to be surrounded by the bezel 34. As shown in FIG. 1, the display 20a of the watch main body 20 is exposed to a front side from the bezel 34 as a result of the watch main body 20 being fitted in the bezel 34. In addition, a first crown hole 34b is provided in each of four corner portions of the bezel 34 for passage of the corresponding crown 22a provided on the watch main body 20.

The pair of connectors 36 are provided in such a manner as to connect the bezel 34 with the first band 32a and the bezel 34 with the second band 32b, respectively. That is, in the wearing component part 30, the band 32 and the bezel 34 are provided in such a manner as to continue to each other via the connectors 36. Two attachment holes 36a are provided on each connector 36 for attachment of the corresponding string attachment component part 70. The two attachment holes 36a penetrate in the front-rear direction and are aligned side by side in a left-right direction in parallel with each other. In each connector 36, portions where the attachment holes 36a are provided are made thinner in thickness than other portions, whereby the first band 32a and the second band 32b are made to bend easily to the rear from the bezel 34.

The four external corner component parts 50 each have a shape which follows each of four corners of the bezel 34 and have the same shape. The four external corner component parts 50 are configured to be fitted on an external circumferential portion of the bezel 34 from the front side through a concave/convex fitting. The four external corner component parts 50 are colored in, for example, a color which differs from that of the wearing component part 30. In addition, the four external corner component parts 50 are also colored in different colors. As a result, the decorativeness of the wristwatch 10 is enhanced. Additionally, a second crown hole 50a is provided in each of the four external corner component parts 50 for passage of each of the crowns 22a provided on the watch main body 20.

The pair of string attachment component parts 70 are constituent components for attaching the pair of string component parts 60 to the wearing component part 30. Each string attachment component part 70 has a plate-shaped component 70a in the form of a substantially thick plate and two string passage holes 70b which are provided on the plate-shaped component 70a. Each string passage hole 70b has substantially an arch shape which penetrates in the left-right direction. This arch-shaped string passage hole 70b is provided in such a manner as to protrude to the front from a front surface of the plate-shaped component 70a. Each string attachment component part 70 is assembled to the corresponding connector 36 from a rear side thereof in such a manner that the string passage hole 70b is passed through the corresponding attachment hole 36a from the rear so as to be exposed to the front side.

The pair of string component parts 60 are looped short string components for use to attach the pair of upper and lower external component parts 72 to the wearing component part 30 and are passed individually through the two string passage holes 70b which are exposed to the front side of the connectors 36. That is, one string component part 60 is attached to one string attachment component part 70. The pair of upper and lower external component parts 72 are each a substantially circular cylindrical component, and the string component part 60 is passed through an inside of the corresponding string attachment component part 72 to hold the string attachment component part 72 in place. The upper and lower external component parts 72 are held while being disposed to be positioned individually on an upper side and a lower side of the display 20a. Specifically speaking, the upper and lower external component parts 72 are disposed individually in the vicinity of an upper end a lower end of an external circumferential portion of the display 20a. For example, a logo or the like can be displayed on a front surface of each of the upper and lower external component parts 72 which are held individually on the upper side and the lower side of the display 20a, thereby making it possible to enhance the decorativeness of the wristwatch 10.

The pair of string fastening component parts 74 are a substantially quadrangular cylindrical component and hold the pair of string component parts 60 by collectively narrowing end portions of the pair of string component parts 60 which are not held individually by the upper and lower external component parts 72 (end portions of the pair of looped string component parts 60) for passage through insides of quadrangular cylindrical spaces of the pair of string fastening component parts 74. String passage holes 72b are interposed between the string fastening component parts 74 and the upper and lower external component parts 72 in an up-down direction. Additionally, at least portions of the pair of string component parts 60 which are exposed from left and right passage holes of the upper and lower external component parts 72 to extend towards the corresponding two string passage holes 70b are caught between the bezel 34 and the four external corner component parts 50, whereby the positions of the pair of string component parts 60 are made to hardly move. In this state, by causing the positions of the string fastening component parts 74 to deviate towards the corresponding string passage holes 72b to thereby fasten the corresponding string component parts 60, a looseness in each of the pair of string component parts 60 can be removed.

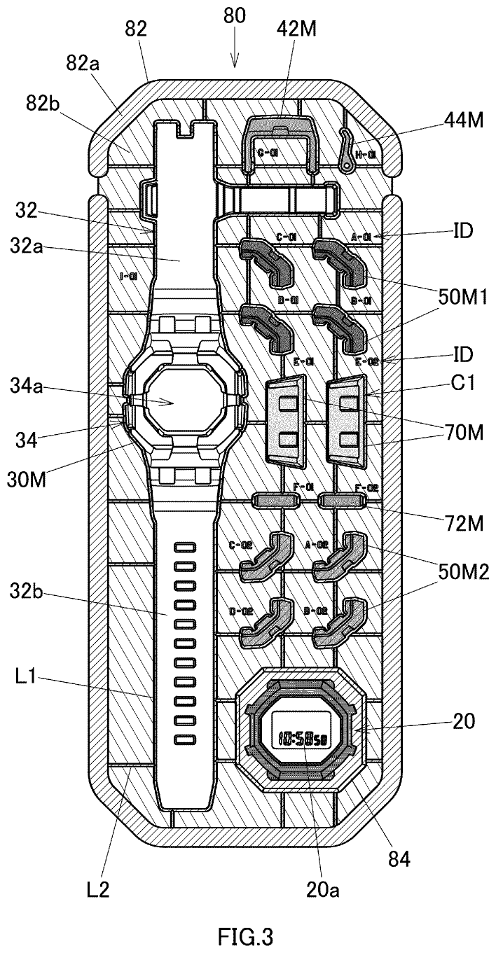

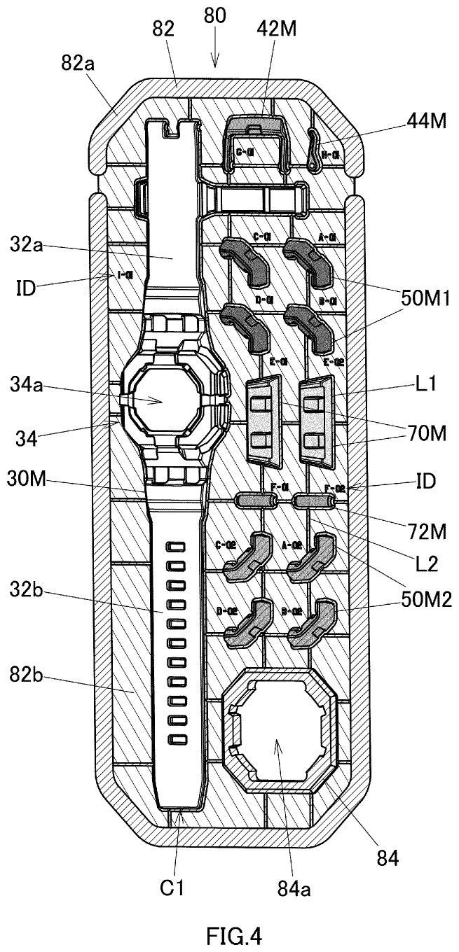

Subsequently, referring to FIGS. 3 and 4, a molded part 80 according to the first embodiment of the present disclosure will be described. As shown in FIGS. 3 and 4, a whole of the molded part 80 is provided by compression molding a urethane resin into a single molded unit, and the molded part 80 has a substantially rectangular resin plate 82. The resin plate 82 has an external edge area (a third runner) 82a which makes up an external edge of the resin plate 82, a sheet area 82b of a sheet-like shape which is provided inside the external edge area 82a, and the component parts provided on or above the sheet area 82b. (Here, each component part is a separate part from the sheet area 82b.) The external edge area 82a is positioned on the external frame of the resin plate 82. As shown in FIGS. 3 and 4, the external edge area 82a has a shape where a part is cut out in the left and right positions on the upper side. That is, gaps are provided partially in the external edge area 82a so as to improve a flow of resin since the flow of resin is deteriorated if the molded part 80 is fully surrounded by the external edge area 82a, resulting in a risk of a molding failure. In this way, a place to create a flow of resin is necessary to be formed somewhere along the length of the external edge area 82a. As shown in FIG. 4, all the component parts which make up the wristwatch 10 excluding the watch main body 20, the pair of string component parts 60, the pair of string fastening component parts 74, and the screws are provided on or above the sheet area 82b. In the following description, an alphabetical character M will be added to reference symbols of the component parts provided on or above the sheet area 82b and left not yet assembled as designed.

Specifically speaking, as shown in FIG. 4, a wearing component part 30M, a buckle component part 42M, a prong component part 44M, external corner component parts 50M1, 50M2, a pair of string attachment component parts 70M, and a pair of upper and lower external component parts 72M are provided on or above the sheet area 82b while being spaced apart from one another in such a manner as to be separable from the sheet area 82b. Further, the watch main body 20 is provided on or above the sheet area 82b (refer to FIG. 3). The watch main body 20 is not a part of the molded part 80 and is fitted into the fitting hole 84a in the fitting edge portion 84 on or above the sheet area 82b after the molding of the molded part 80. Here, although there are four external corner component parts 50M1, 50M2 to be assembled to the watch main body 20, in the first embodiment, the external corner component parts 50M1, 50M2 with different colors from each other are provided on or above the sheet area 82b.

The molded part 80 is molded with a mixture of multiple different colors. In the first embodiment, for example, the wearing component part 30M and the sheet area 82b are molded in a grey color, the buckle component part 42M and the prong component part 44M are molded in a red color, and among the eight external corner component parts 50M1, 50M2, the four external corner component parts 50M1, which are provided on the upper side of the sheet area 82b, are molded in a blue color, while the four external corner component parts 50M2, which are provided on the lower side of the sheet area 82b, are molded in a green color. Then, the pair of attachment component parts 70M are molded in a black color, and the pair of upper and lower external component parts 72M are molded in a purple color.

First runners L1 are provided around the component parts (excluding the watch main body 20) provided on or above the sheet area 82b in such a manner as to surround the component parts. Additionally, second runners L2 are provided on or above the sheet area 82b in a grid-like fashion in such a manner as not only to connect adjacent first runners L1 together but also to connect the external edge area (the third runner) 82a with the first runners L1. Here, the external edge area 82a is formed thicker than the first runners L1 and the second runners L2. Trimming lines C1 are provided intermittently in boundary portions defined between the component parts and the first runners L1. As a result, the component parts can easily be removed to be from the sheet area 82b by being pushed to the rear side. The first runners L1 and the second runners L2 are formed into a thick structure so as to function as a reinforcement rib for preventing an occurrence of breakage in the sheet area 82b when the component parts are removed from the sheet area 82b.

Identifier symbols ID are given individually in proximity to the component parts for identification of the corresponding component parts. The identifier symbols ID take the form of “an alphabetical character − (numerals)”. In the identifier symbols ID, any one of alphabetical characters A to F is used for a portion represented by (an alphabetical character) to denote a type of a component part, and 01 or 02 is used for a portion represented by (a numeral). On the sheet area 82b, guidance indicators (not shown) corresponding to the identifier symbols ID of the external corner component parts 50 to be fitted are shown individually in the four corners of the external circumference of the bezel 34.

As shown in FIG. 4, the fitting hole 84a, into which the watch main body 20 is to be fitted, is provided in a portion of the sheet area 82b. A shape matching an outline of the watch main body 20 is given to the fitting hole 84a, so that the watch main body 20 is fitted in the fitting hole 84a without any gap defined therebetween in an ensured fashion. The fitting edge portion 84 is provided around the fitting hole 84a on the sheet area 82b in such a manner as to protrude upwardly therefrom so as to surround the fitting hole 84a. As a result, the durability of the fitting hole 84a is enhanced so high that a deformation or a breakage can hardly be caused in the vicinity of the fitting hole 84a in the sheet area 82b due to the weight or the like of the watch main body 20 when the watch main body 20 is fitted in the fitting hole 84a.

Subsequently, an assembling procedure will be described by which the user assembles the component parts of the molded part 80 into the wristwatch 10 according to the first embodiment. The molded part 80 of the first embodiment is sold as one product as, for example, a “wristwatch assembly set” with the watch main body 20 fitted accordingly which comes together with the pair of string component parts 60, the pair string fastening component parts 74, and the screws. Then, the user who acquires this product removes the individual component parts and the watch main body 20 from the sheet area 82b of the molded part 80 to assemble them freely together with the other component parts which are not provided on the sheet area 82b, whereby the user can continue the assembling work of the wristwatch 10.

For this, the component parts, which are necessary to attach the upper and lower external component parts 72M in front of the bezel 34, that is, the pair of upper and lower external component parts 72M, the pair of string component parts 60, the pair of string attachment component parts 70, and the pair of string fastening component parts 74 are assembled to the wearing component part 30 before the external corner component parts 50 are assembled thereto. Thereafter, the external corner component parts 50M1 or 50M2 are assembled to the wearing component part 30, whereby the portions of the pair of string component parts 60 can be caught between the bezel 34 and the external corner component parts 50M1 or 50M2. The eight external corner component parts 50M, 50M2, which are provided on or above the sheet area 82b in the two different colors, have the same shape or configuration, so that the user can select any four external corner component parts from the eight external corner component parts 50M1, 50M2 so provided to assemble the four external corner component parts so selected to any of the four corners of the external circumference of the bezel 34, that is, the four external corner component parts so selected can freely be disposed in any of four corners of the external circumference of the bezel 34. As a result, the use can enjoy selecting and assembling any four external corner component parts from the eight external corner component parts 50M1, 50M2 so as to match his or her desired coloring plan.

In this way, all the necessary component parts are assembled, and the assembled portions of the component parts so assembled are fastened with the screws, whereby the wristwatch 10 can be built up. The residual of the molded part 80 after the component parts are removed therefrom may be collected by a sales company of the product for reuse. This can help to reduce the environmental load. Here, since the molded part 80 is provided as a single molded unit through compression molding, although there may be a case in which burs are left on an external circumferential portion of a molded part at the time of molding, the external circumferential portion constitutes the residual of the molded part 80 left after the wristwatch 10 is built up. Hence, even in the event that burs are so left, there is no case in which the burs cause any problem affecting the quality of a product.

Thus, as has been described heretofore, the molded part 80 of the first embodiment includes the resin plate 82 molded from the urethane material, and the resin plate 82 has the sheet area 82b of the sheet-like shape and the multiple assembly component parts for assemblage to the watch main body 20. Then, the sheet area 82b and the multiple assembly component parts are molded into the planar single molded unit, and the multiple assembly component parts are configured to be individually separable from the sheet area 82b. The material and distribution costs of the constituent component parts that will be incurred during the manufacturing process of equipment such as a watch or the like can be reduced by collectively providing the component parts configured to be assembled to the watch main body 20 on or above the sheet area 82b of the molded part 80 which is molded from the same urethane material into the single molded unit in a separable fashion in the way described above, thereby making it possible to reduce the environmental load. Further, the residual of the molded part 80 left after the removal of the component parts therefrom can be collected for reuse, and hence, the environmental load can also be reduced from this respect.

In addition, equipment such as a watch is manufactured by assembling multiple component parts, and multiple manufacturing processes are involved before the equipment is completed as a final product, as a result of which the material and distribution costs are accumulated, and waste parts resulting from the manufacturing processes also constitute an environmental load. However, the component parts which are assembled into such equipment are molded from the resin material that can be reused into the single molded unit as the molded part 80, thereby making it possible to reduce the environmental load.

With the molded part 80, the resin plate 82 is formed by compression molding the resin material. In the event that a molded part 80 is provided through injection molding, resulting component parts are provided in such a manner as to be continuously connected onto runners (first runners L1, second runners L2), and hence, the component parts cannot be provided on or above a single sheet (on or above the sheet area 82b). However, since the molded part 80 is provided by compression molding, the component parts can collectively be provided on or above the sheet area 82b, and this contributes to a reduction in environmental load.

With the molded part 80, the resin material is the urethane material. In this way, the molded part 80 can be provided effectively by compression molding using the urethane resin which is suitable for compression molding for the resin material from which the molded part 80 is molded.

Additionally, with the molded part 80, the multiple assembly component parts are molded individually with a mixture of at least two different colors. As a result, the use can enjoy selecting and assembling freely any assembly component parts in the multiple assembly component parts which are so colored to desired positions on the watch main body 20 so as to match his or her desired coloring plan.

With the resin plate 82 of the molded part 80, the trimming lines C1 are provided intermittently in the boundary portions defined individually between the sheet area 82b and the assembly component parts. As a result, when the user wishes to remove the assembly component parts from the sheet area 82b, its easy removal along the trimming lines C1 can be facilitated by pushing each assembly component parts to the rear side by the user.

With the molded part 80, the module component part is the watch main body 20, and the multiple assembly component parts include the band component part 32 configured to enable the watch main body 20 to be worn on a wrist of a user, the bezel 34 configured to be assembled in such a manner as to surround the watch main body 20, and the external corner component parts 50 configured to be assembled to the external circumferential portion of the bezel 34. According to this configuration, the watch (the wristwatch 10) can be manufactured by assembling the component parts provided on or above the sheet area 82b of the molded part 80 to the watch main body 20, thereby making it possible to reduce the environmental load during the manufacturing processes of the watch (the wristwatch 10).

With the molded part 80, the band 32 and the bezel 34 are provided continuously in the resin plate 82. According to this configuration, in the case that the component parts configured to be assembled to the watch main body 20 are provided in the molded part 80, compared with a case in which the band 32 and the bezel 34 are provided separately, the amount of the residual of the molded part 80 resulting after the band 32 and the bezel 34 are removed from the sheet area 82b can be suppressed to a lower level, thereby making it possible to reduce further the environmental load in the manufacturing processes of the watch.

With the molded part 80, the identifier symbols ID, which differ according to the types of the multiple assembly component parts, are provided individually in proximity to those multiple assembly component parts in the sheet area 82b. As a result, when the component parts are removed individually from the sheet area 82b to be assembled to the watch main body 20, the difference in the types of the component parts can be identified, thereby facilitating the assemblage of the component parts to the watch main body 20.

In the first embodiment, the watch main body 20 and the multiple assembly component parts which are molded from the urethane resin into the single molded unit for assemblage to the watch main body 20 are combined together to make up the wristwatch 10. As a result, not only the material and distribution costs during the manufacturing processes of the wristwatch 10 can be reduced, but also the residual of the molded part 80 resulting from the manufacturing processes can be reused, thereby making it possible to realize the wristwatch 10 which can contribute to a reduction in the environmental load.

With the first embodiment, the molded part has the plate shape, and this obviates the necessity of packing the multiple assembly component parts separately, allowing the multiple component parts to be packed collectively into a compact package. As a result, the distribution cost can be reduced. Further, the component parts configured to be assembled to such equipment as the wristwatch 10 are integrated from the resin material into the single unit as a molded part, thereby making it possible to simplify the transport work which tends to be complicated and troublesome.

### Second Embodiment

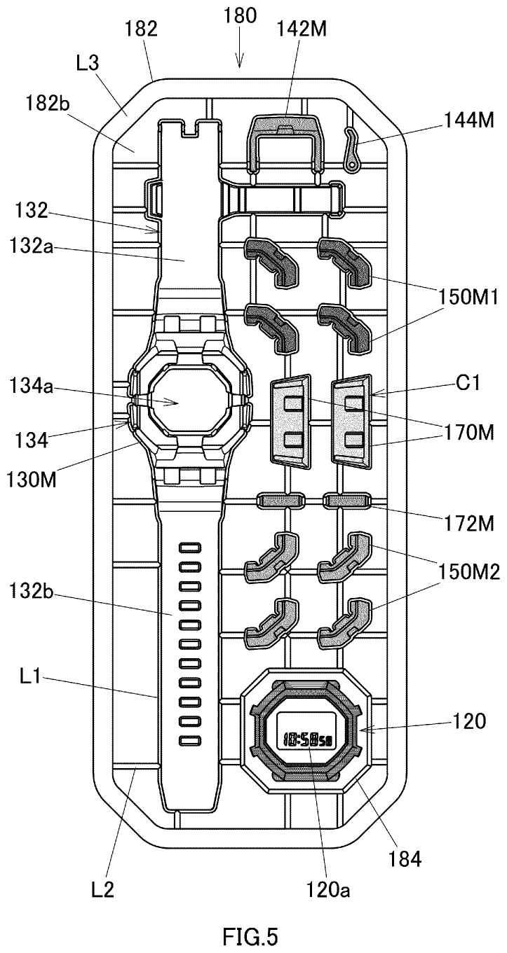

Subsequently, referring to FIG. 5, a second embodiment of the present disclosure will be described. As shown in FIG. 5, a whole of a molded part 180 is provided by injection molding resin material into a single molded unit, and the molded part 180 has a resin frame 182 of a frame shape. In the resin frame 182, multiple assembly component parts configured to be assembled to a watch main body (a module component part) 120 are provided in such a manner as to be surrounded by a third runner L3 which makes up an external frame. As with the molded part 80 of the first embodiment, a wearing component part 130M, a buckle component part 142M, a prong component part 144M, external corner component parts 150M1, 150M2, a pair of string attachment component parts 170M, and a pair of upper and lower external component parts 172M are provided while being spaced apart from one another in such a manner as to be separable from the resin frame 182.

Further, the watch main body 120 is provided in the resin frame 182. The watch main body 120 is not a part of the molded part 180 and is fitted into a fitting edge portion (an edge portion) 184 in the resin frame 182 after the molding of the molded part 180.

First runners L1 are provided around the multiple assembly component parts provided in the resin frame 182 in such a manner as to individually surround the multiple assembly component parts. In addition, second runners L2 are provided in the resin frame 182 in a grid-like fashion in such a manner as not only to connect adjacent first runners L1 together but also to connect the first runners L1 with the third runner L3. The first runners L1 and the fitting edge portion 184, and the third runner L3 and the fitting edge portion 184 are individually connected together by the second runners L2.

The multiple assembly component parts, the first runners L1, the third runner L3, the second runners L2, and the fitting edge portion 184 are formed from the resin material into a single unit. Trimming lines C1 are provided intermittently in boundary portions defined between the multiple component parts and the first runners L1. As a result, the component parts are configured to be easily removed and from the resin frame 182 by being pushed to a rear side.

Also, with the molded part 180 of the second embodiment which is configured as described above, the component parts configured to be assembled to the watch main body 120 are provided collectively in a separable fashion in the resin frame 182 of the molded part 180 which is molded from the same resin material into the single molded unit, thereby making it possible not only to reduce the material and distribution costs in manufacturing processes of such equipment as the wristwatch 10 but also to reduce the environmental load. Further, the environmental load can also be reduced by molding the component parts configured to be assembled to such equipment as the wristwatch 10 from the resin material that can be reused into the single molded unit as the molded part 180.

In addition, the molded part 180 of the second embodiment has the first runners L1, the third runner L3, the second runners L2, the multiple assembly component parts configured to be assembled to the watch main body 120, and the fitting edge portion 184 in which a fitting hole is formed, and the first runners L1, the third runner L3, the second runners L2, the multiple assembly component parts, and the fitting edge portion 184 are integrated into the single unit. Then, the molded part 180 includes the resin frame 182 which is molded from the resin material and the watch main body 120 which is fitted in the fitting hole in the fitting edge portion 184, and the multiple assembly component parts are configured to be individually separable from the first runners L1, the third runner L3, and the second runners L2. In this way, the multiple assembly component parts are individually integrated from the resin material into the single unit as the molded part, thereby making it possible to simplify the transport work that tends to be complicated and troublesome.

The embodiments that have been described heretofore are presented as the examples, and hence, there is no intention to limit the scope of the present invention by the embodiments. The novel embodiments can be carried out in other various forms, and various omissions, replacements and modifications can be made thereto without departing from the spirit and scope of the present invention. Those resulting embodiments and modified examples thereof are included in the scope and gist of the present invention and are also included in the scope of inventions claimed for patent under claims below and their equivalents. For example, in the embodiments that have been described heretofore, while the watch main body is described as the example of the module component part, the equipment that is manufactured by assembling the component parts provided on, above, or in the molded parts of the present invention is described as being the watch, the present invention is not limited thereto, and hence, other pieces of equipment may be adopted. In addition, in the embodiments that have been described heretofore, while the urethan resin is described as being the resin material from which the molded part is molded, the present invention is not limited thereto, and hence, other resin materials may be used.

What is claimed is:

1. A molded part comprising:
a resin plate molded from resin material,
wherein the resin plate comprises a sheet area of a sheet-like shape and multiple assembly component parts for assemblage to a module component part, the sheet area and the multiple assembly component parts being integrated into a single unit, and
wherein the multiple assembly component parts are configured to be individually separable from the sheet area.

2. The molded part according to claim 1,
wherein the sheet area and the multiple assembly component parts are molded into a single molded unit.

3. The molded part according to claim 1, comprising:
first runners configured to surround individually the multiple assembly component parts.

4. The molded part according to claim 3, comprising:
second runners configured to connect individually adjacent ones of the first runners together.

5. A molded part comprising:
a resin frame comprising a runner component part, multiple assembly component parts for assemblage to a module component part, and an edge portion having a hole formed therein, wherein the resin frame is molded from resin material and is configured to integrate the runner component part, the multiple assembly component parts, and the edge portion into a single unit; and
a module component part fitted in the hole in the edge portion,
wherein the multiple assembly component parts are configured to be individually separable from the runner component part.

6. The molded part according to claim 5,
wherein the runner component part comprises first runners configured to surround individually the multiple assembly component parts, a third runner making up an external frame, and second runners configured to connect individually adjacent ones of the first runners together, and the first runners and the third runner together, and
wherein the first runners and the edge portion, and the third runner and the edge portion are connected together by the second runners.

7. The molded part according to claim 1,
wherein the resin plate is formed by compression molding the resin material.

8. The molded part according to claim 5,
wherein the resin plate is formed by compression molding the resin material.

9. The molded part according to claim 2,
wherein the resin material is a urethane resin.

10. The molded part according to claim 2,
wherein the multiple assembly component parts are molded individually with a mixture of at least two different colors.

11. The molded part according to claim 1,
wherein the resin plate comprises trimming lines which are provided intermittently in boundary portions defined between the sheet area and each of the multiple assembly component parts.

12. The molded part according to claim 5,
wherein the resin plate comprises trimming lines which are provided intermittently in boundary portions defined between the sheet area and each of the multiple assembly component parts.

13. The molded part according to claim 1,
wherein the module component part is a watch main body, and
wherein the multiple assembly component parts comprise a band component part configured to enable the watch main body to be worn on a wrist of a user, a bezel component part configured to be assembled in such a manner as to surround the watch main body, and an external component part configured to be assembled to an external circumferential portion of the bezel component part.

14. The molded part according to claim 5,
wherein the module component part is a watch main body, and
wherein the multiple assembly component parts comprise a band component part configured to enable the watch main body to be worn on a wrist of a user, a bezel component part configured to be assembled in such a manner as to surround the watch main body, and an external component part configured to be assembled to an external circumferential portion of the bezel component part.

15. The molded part according to claim 11,
wherein the band component part and the bezel component part are provided continuously in the resin plate.

16. The molded part according to claim 1,
wherein the sheet area comprises identifier symbols, which differ according to types of the multiple assembly component parts, provided individually in proximity to the multiple assembly component parts.

17. A watch comprising in combination:
a watch main body; and
multiple assembly component parts integrated into a single unit from resin material and configured to be assembled to the watch main body.
